(19) United States
(12) Patent Application Publication
(10) Pub. No.: US 2006/0179409 A1
(43) Pub. Date: Aug. 10, 2006

(54) Method and system for monitoring conditions for organizational change

(76) Inventor: Martin H. Kaisermayr, Antibes (FR)

Correspondence Address: KENYON & KENYON LLP, 1500 K STREET N.W., SUITE 700, WASHINGTON, DC, 20005, US

(21) Appl. No.: 11/052,297

(22) Filed: Feb. 8, 2005

(51) Int. Cl. G06F 17/00

(52) U.S. Cl. 715/736

(57) ABSTRACT

A method and system of causing the execution of a predefined set of instructions upon an occurrence of certain conditions is disclosed. In some embodiments, the method includes detecting a change in an occupation state of a job position and determining if a certain marker is associated with an organizational unit at or above the organizational unit associated with the employee. If the certain marker is associated, then a workflow may be executed to notify the user. In some embodiments, the method includes determining a monitor condition associated with a marker for organizational change and determining, as a function of the monitor condition and an attribute associated with the employee, whether all conditions relevant to the monitor condition are satisfied. If all conditions are satisfied a workflow may be executed. In some embodiments, a system may include a processor, a memory, and an output device used to perform the steps of a method in accordance with the invention.

### BACKGROUND

This application is related to U.S. patent application entitled “Monitor for Reorganizations on The Level of Organizational Units” by Martin H. Kaisermayr and Andy Peichl, which was filed on a date even herewith and is incorporated herein by reference in its entirety.

A change in an organizational structure of a public, private, or governmental organization (“organization”) often experiences a time-delay before the change can be effected. Examples of organizational change include termination of employment or modification of an employment position of any employee. Reasons for the time-delay between an order to change and the implementation of the change in the organizational structure may include observance of legal requirements or internal business policies. These requirements or policies may necessitate a delay until an employee, or class of employees, that is the subject of the change (collectively, the “targeted employee”) leaves his position. A targeted employee may leave his position, for example, through retirement, finding employment elsewhere, or advancement or demotion within the organization itself, just to name a few.

In many situations, but especially in situations where an organization has hundreds or thousands of employees, it becomes difficult to implement orders for organizational change due to lapses in the organization's “memory.” A lapse in an organization's memory may result when personnel in charge of monitoring conditions for change, or personnel in charge of implementing the changes, have a change of their own employment state. A lapse may result when personnel become involved with other tasks and forget to monitor and implement organizational changes. A lapse may also be attributed to delays between orders to change the organizational structure (e.g., reduce the number of personnel in a workforce) and implementation of those orders. Poor record keeping and/or lack of procedures or failure to follow procedures required to perform the required tasks may contribute to and may exacerbate the lapse of an organization's memory. What would be useful, and what is needed is a method and system to monitor conditions for organizational changes and to transmit timely notifications to predefined personnel of the occurrence of these conditions.

### BRIEF DESCRIPTION OF THE DRAWINGS

FIG. 1 illustrates a method for monitoring conditions for organizational changes and for causing the execution of a predefined set of instructions upon an occurrence of these conditions, in accordance with an embodiment of the invention.

FIG. 2 is a simplified block diagram of a system for monitoring conditions for organizational changes and for causing the execution of a predefined set of instructions upon an occurrence of these conditions, in accordance with an embodiment of the invention.

FIG. 3 is a tree-like organization structure, which illustrates some exemplary organizational units in accordance with an embodiment of the invention.

FIG. 4 illustrates an overall implementation of a method in accordance with an embodiment of the invention.

### DETAILED DESCRIPTION

A system and method for monitoring conditions for organizational changes and for causing the execution of a set of predefined instructions upon the occurrence of certain ones of these conditions is presented herein.

An organizational change may be indicated if a first employee in a plurality of employees in an organizational unit has a change in, for example, his employment state or employment position (collectively, “employment state”). The first employee may change his employment state by, for example, leaving the employment of his organizational unit due to voluntary or involuntary termination, retirement, transfer to another organizational unit, sickness, or vertical or lateral promotion or demotion to another position within his organizational unit. The change in employment state brings about a change in an “occupation state” of the job position formerly held by the employee.

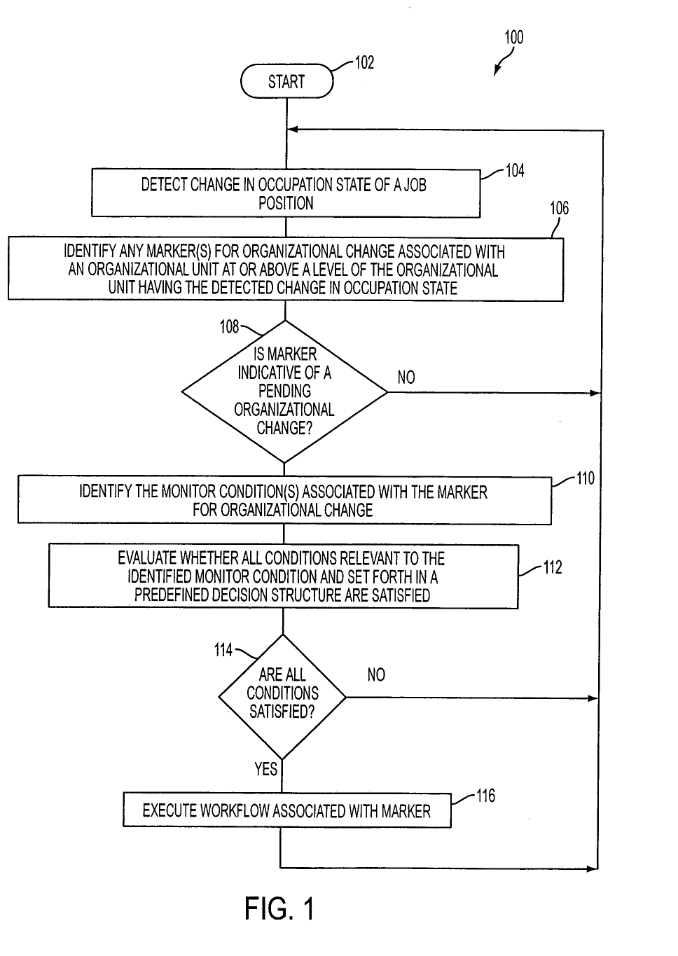

FIG. 1 illustrates a method 100 for monitoring conditions for organizational changes and for causing the execution of a predefined set of instructions upon an occurrence of these conditions, in accordance with an embodiment of the invention. The method may begin at 102.

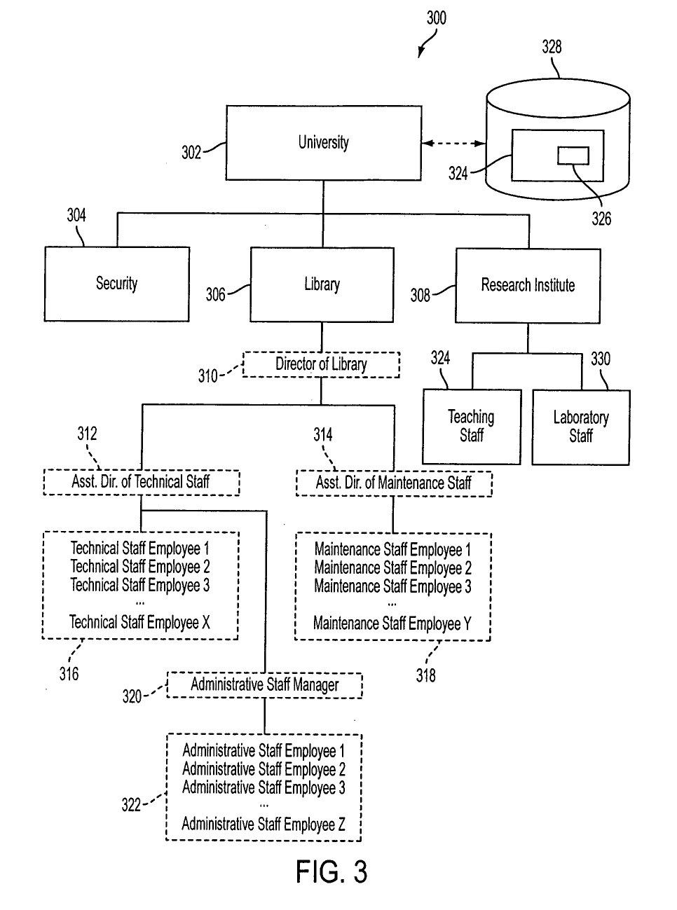

At 104, an occurrence of a change in an occupation state of a job position may be detected. Detection of the change in occupation state of a job position may be facilitated, for example, via manually entered data or by an automatic process. An example of a manually entered data may include the enabling or disabling of a flag associated with the position's occupation state. A system in accordance with an embodiment of the invention may enable certain users (e.g., users preauthorized to modify employment records) to modify the occupation state of a job position. Thus, upon resignation or retirement of Library Technical Staff Employee 2 (part of 316, FIG. 3), a preauthorized user may execute a transaction on the system to change the occupation state of Library Technical Staff Employee 2. The occupation state of all employees, including that of Library Technical Staff Employee 2, may be stored in one or more locations, such as a memory 204, 328.

An example of an automatic process may include the implementation of a check in program modules that are responsible for changing the employment state on a database. Accordingly, every time the program changes something employment-related on the database the change would be processed by a program module that checks whether this change is relevant by enabling further organizational changes or not. Detection may be realized in other ways as well.

At 106, the method may identify any marker for organizational change (the “marker”) that is associated with an organizational unit at or above a level of the organizational unit associated with the job position whose occupation state has changed. More than one marker may be identified.

As described in more detail hereinafter, the marker may be one of many types. Moreover, the marker may be associated with one or more organizational units. In some embodiments, the marker may be set to one of two states. A first state may be indicative of an organizational change within an organizational unit associated with the marker. A second state may be indicative of no organizational change within an organizational unit associated with the marker. The change in state of the marker may be facilitated in several ways. For example, a system in accordance with an embodiment of the invention may enable certain users (e.g., users preauthorized to modify employment records) to modify the state of the marker. A process designed to take place during the exiting of an employee from an organization may include a manual step wherein the authorized person is instructed to change the state of the marker. A change in the state of the marker may be realized in other ways as well.

At 108, if a marker is associated with an organizational unit at or above a level of the organizational unit associated with the job position whose occupation state has changed, and optionally, if the marker is indicative of a pending order for organizational change, then the method may continue to 110. Otherwise, the method may return to 104 and wait for the next occurrence of a detection of a change in an occupation state of a job position. At 110, an identification of a Monitor Condition associated with the marker occurs. At 112, an evaluation as to whether all conditions relevant to the identified Monitor Condition have been satisfied occurs. The conditions relevant to a Monitor Condition may be set forth in a predefined decision structure. Monitor Conditions and decision structures, as used herein, are explained hereinbelow. At 114, if all Monitor Conditions are satisfied, the method may continue to 116. Otherwise, the method may return to 104 and wait for the next occurrence of a detection of a change in an occupation state of a job position. At 116, a workflow (i.e., a set of predefined instructions) that is associated with the marker may be executed. Following execution, the method may return to 104 and wait for the next occurrence of a detection of a change in an occupation state of a job position.

A Monitor Condition, as used herein, is a predefined condition that must be satisfied before a workflow is executed. Each type of marker may be associated with at least one Monitor Condition.

At 110, a method in accordance with an embodiment of the invention may identify the Monitor Condition(s) associated with the marker. At 112, a method in accordance with an embodiment of the invention may identify, as a function of the Monitor Condition and an attribute associated with the job position, whether all conditions relevant to the Monitor Condition are satisfied. The conditions relevant to the monitor condition may be set forth in a predefined decision structure. At 114, if all relevant conditions are satisfied, then at 116, a set of predefined instructions associated with the marker may be executed. If not, or once the set of predefined instructions has been executed, the method may return to 104 and wait for the next occurrence of a detection of a change in an occupation state of a position.

As used herein, the set of predefined instructions may be referred to as a “workflow.” A workflow may, for example, may include instructions to transmit a notification to one or more users and may incorporate instructions to perform predefined tasks. A predefined task may include, for example, automatically locking the job position (e.g., to disallow an increase in the number of persons working in a marked organizational unit), suppressing the re-filling of the job position, blocking the re-filling of the job position, or reclassifying the job position. In some embodiments, “locking” may prevent the filling of the employment position formerly held by an exiting employee. More broadly, a workflow is an automated business process that may pass documents or information (such as notification of change of organizational state) from one resource to another, and/or may execute tasks (such as locking an employment position) all according to a set of procedural rules. The resource may be human and/or machine. In some embodiments, a workflow may send one or more pop-ups, e-mail messages, or other forms of notification to one or more predefined users.

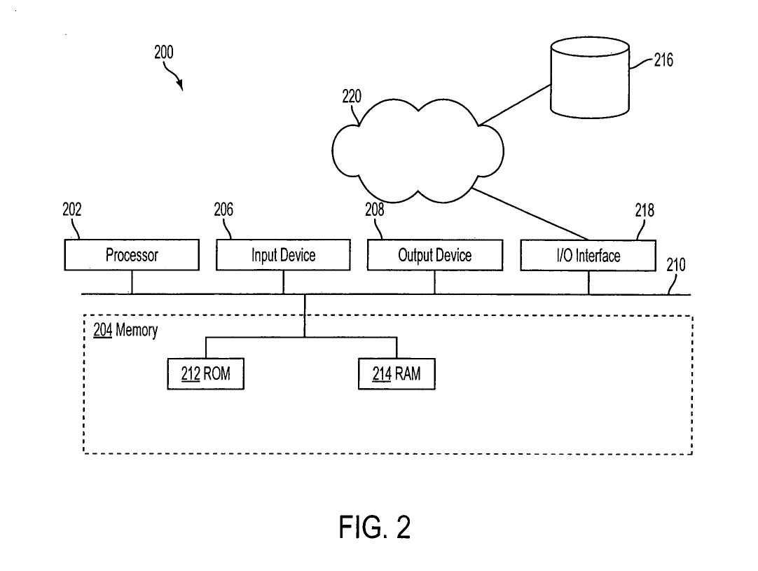

FIG. 2 is a simplified block diagram of a system 200 for monitoring conditions for organizational changes and for causing the execution of a predefined set of instructions upon an occurrence of these conditions, in accordance with an embodiment of the invention. The system 200 is illustrated as including a processor 202, a memory system 204, an input device 206, and an output device 208. One or more busses 210 (e.g., communications bus, data bus, etc.) may couple some or all of the components of the system 200. The processor 202 may be any of a plurality of conventional processing systems, including microprocessors, digital signal processors, and field programmable logic arrays. In some embodiments, it may be advantageous to provide multiple processors (not shown) in the system 200. The processor 202 may execute program instructions stored in the memory system 204. The memory system 204 may include any combination of conventional memory circuits, including electrical, magnetic, or optical memory systems. As shown in FIG. 2, the memory system may include, for example, read only memories 212 and random access memories 214. Components of the memory system may be located remotely from the processor. For example, a hard disk or bulk storage device 216 may not be in physical proximity of the processor 202 but may be located, for example, on the other side of the world. This hard disk or bulk storage device 216 may be coupled to the system 200 via an I/O interface 218 and a communications network 220, such as the Internet. Of course, input and output devices 206, 208 may also be remotely coupled to the system. The memory system 204 not only stores program instructions that may embody various methods described herein but may also store data on which these methods operate.

As used herein, an organizational structure may be thought of as a structure or schema of an organization's workforce. An organization, such as a university, may have its workforce divided as shown in FIG. 3. FIG. 3 is a tree-like organization structure 300, which illustrates some exemplary organizational units in accordance with an embodiment of the invention. For example, University 302, Security 304, Library 306, and Research Institute 308 may all be organizational units.

Each of these organizational units may have personnel working under their auspices. For example, in FIG. 3, Library 306 is illustrated as having personnel organized in a tree-like structure. A director of the Library 310 is illustrated as overseeing the work of the assistant directors for library technical staff 312 and library maintenance staff 314. Each of these assistant directors is illustrated as overseeing the work of several employees 316, 318. The assistant director for library technical staff 312 also oversees the work of an administrative staff manager 320, who in turn oversees the work of several employees 322. These employees 316, 318, 322 are identified as technical staff employee 1 through technical staff employee X, maintenance staff employee 1 through maintenance staff employee Y, and administrative staff employee 1 through administrative staff employee Z, respectively. It is noted that X, Y and Z are positive integers that may or may not be equal. All personnel may have associated with them one or more attributes. The attributes may include, for example, job position, employment state, hire date, salary, tax information, nationality, sex, age, level of education, qualitative measure of performance, etc. All job positions may also have attributes associated with them. Attributes for job positions may include, for example, location, pay scale level, and qualification profile. Attributes may typically be stored in one or more databases or tables. For ease of illustration, attributes may be stored in a database 324 or table 326, each of which may be stored in memory 328.

An organizational unit may have organizational units below it. This case is illustrated for the Research Institute 308, which has a Teaching Staff 324 organizational unit and a Laboratory Staff 330 organizational unit below it. Each organizational unit may be further subdivided as in the case of the Research Institute 308 and/or may have personnel directly beneath it as in the case of the Library 306.

By way of example, a University 302 may want to reduce the number of job positions in its Library 306 by five. For reasons such as those mentioned above, however, it may not be able to reduce its workforce immediately. In accordance with an embodiment of the invention, a marker (e.g., a flag or earmarker) may be associated with the Library 306 organizational unit. The association may be recorded in, for example, a database 324 or table 326 stored on a memory device 328. The marker may indicate that the Library 306 has a pending order for organizational change applied against it. If, as explained above, all conditions for the pending order for change are met, then the system may execute a workflow, comprised of one or more predefined tasks.

The one or more predefined tasks may include sending a notification to predefined personnel. The notification may be in the form of, for example, a pop-up on one or more computer displays of, or e-mail messages transmitted to, the predefined personnel. Other forms of notification are within the scope of the invention. The notification may alert the predefined personnel that they are presently able to process, in part or in whole, the pending order for organizational change that is associated with the marker.

The predefined personnel may be, for example, a direct manager of an exiting employee, a human resources person, or a person in control of monitoring and updating the organizational structure of the organization. Often, the entity that directly manages the exiting employee may not be the same as the entity that manages placement of employees into positions throughout the organization, and likewise may not be the same entity that monitors and updates the organizational structure of the organization.

A monitor for organizational change on a level of organizational units, such as University 302, Security 304, Library 306, Research Institute 308, Research Institute Teaching Staff 324, and Research Institute Laboratory Staff 330 (all represented by solid boxes in FIG. 3), may detect a change in state of a marker associated with the organizational unit. This change, however, may be based on any change in the occupation state of any of the positions in the organizational unit. At such a high organizational level, there may be no evaluation made as to whether the occupation state of the aforementioned position fits within a defined subcategory of positions targeted for organizational change. This subcategory of positions may be identified via the use of Monitor Conditions, as disclose herein.

While notification of any change in occupation state of a job position within an organizational unit is worthwhile, such notification may cause unplanned and/or unnecessary work (e.g., to evaluate why the notification was sent). If the change in occupation state was not caused by a specific event that mandated action, such as evaluation or completion of a pending order of organizational change, then the notification may only amount to a nuisance. Accordingly, the use of Monitor Conditions provides a beneficially selective process, by which notifications may be triggered only on the occurrence of certain predefined conditions.

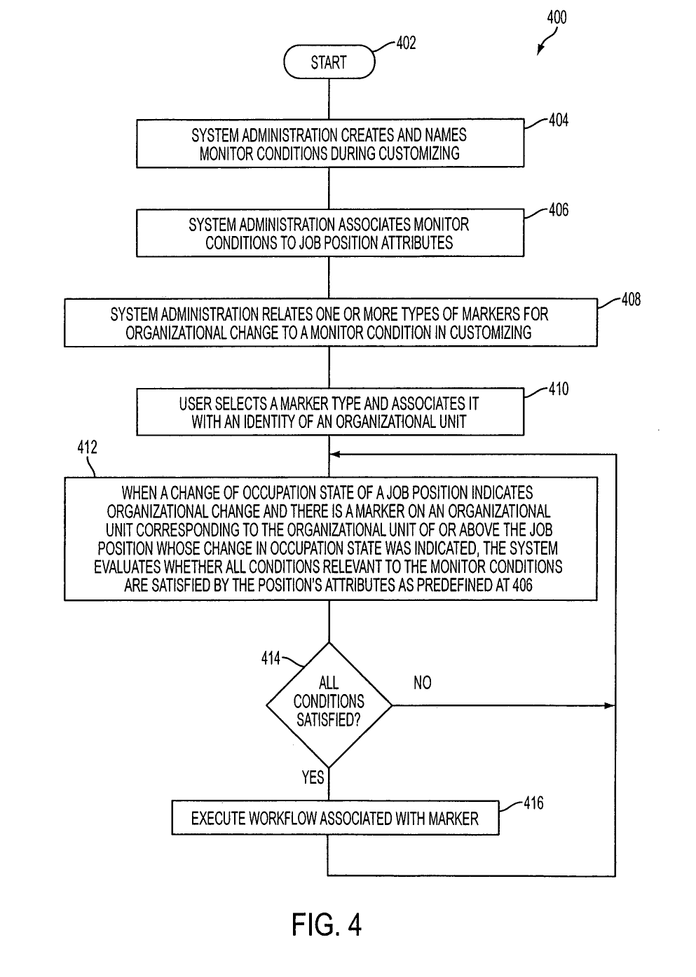

FIG. 4 illustrates an overall implementation 400 of a method in accordance with an embodiment of the invention. At 402, the method may begin. At 404, system administration may create and name Monitor Conditions during customizing.

As used herein, the term “customizing” refers to a process of entry of data to fill variables that are used by a software program. The data may customize the program for the user, (i.e., make it unique to the user). For example, one customization variable may be named “Maintenance Staff Employee 1.” A first user may define this variable as “Senior Custodian” while a second user (at an unaffiliated organization) may define this variable as “Maintenance Worker, First Class.” In any given software program, there may be any number of customization variables. In some embodiments, customizing is something that is not usually implemented or modified by an everyday user. In some embodiments, the software is typically customized once during installation. A specially trained user or a consultant may (or may not) be used to implement customization.

Creation and naming of Monitor Conditions 404 may occur when a system administrator stores a technical name (a.k.a., a Monitor Condition Key or “short name”) and its corresponding long text in a memory. This action may be repeated for each Monitor Condition. By way of example, the system administrator may create the Monitor Condition “RLTS” (i.e., the short name), which is an abbreviation for “Reduce Library Technical Staff” (i.e., the long name). The short name may be a system internal short name and the long name may be used for the benefit and ease of understanding for a user. The short name may be a key, which is by definition a unique technical name. Table 1 is an illustration of an exemplary Monitor Condition naming table. Such a table may be stored, for example, in memory 204, 328.

TABLE 1

| MONITOR CONDITION KEY | MONITOR CONDITION LONG TEXT |
|---|---|
| RLTS | Reduce Library Technical Staff |
| TEC | Technical Staff |
| MNT | Maintenance Staff |
| ADM | Administration |
| EXP | Expensive Position |

At 406, system administration may associate Monitor Conditions to job position attributes. This association may take place during customizing. For example, if the Monitor Condition is “Reduce Library Technical Staff” (key=RLTS), then system administration may design a decision structure that is triggered by the Monitor Condition and that evaluates/compares a parameter associated with the Monitor Condition to the job position's attributes. If the evaluation/comparison satisfies predefined conditions (e.g., evaluation of limits, equalities, greater than, member of, etc.) then a workflow may be executed.

There are at least two methods useful to associate a Monitor Condition key (e.g., RLTS) to job position attributes. A first method may be to exit based on a decision tree (i.e., a tree-like decision structure). A second method may be to exit based on the use of a user defined decision structure that is reached via a “user exit.” In some embodiments, if a tree-like decision structure is employed, the data used in evaluating the conditions may be stored, for example, in a database. In some embodiments, if a user exit is employed (that is, where a user codes his own condition evaluation software) the data used in evaluating the conditions may be stored in a database or a file, depending on the environment of the user. Either the file or the database may be stored in a memory device 204, 328.

### EXAMPLE 1

By way of example, let it be assumed that a Sr. Librarian has just retired from the Library 306. A preauthorized user has accessed the job position attributes and has changed the occupation state of the position formerly occupied by the Sr. Librarian to “not employed” or an equivalent thereof. Further assume that the University 302 had previously (perhaps several months or years earlier) ordered a reduction in the staff of the Library 306 by five persons. A marker was dutifully set to indicate that an order of organizational change was pending against the Library 306. A system executing instructions in accordance with a method of an embodiment of the invention may detect the occurrence of a change in occupation state of the job position formerly held by the Sr. Librarian. The system may consequently identify which organizational unit employed the Sr. Librarian. The system may then identify whether an organizational change marker was associated with the organizational unit at a level of, or above, that of the Library 306. According to this example, a marker was associated with the organizational unit (the Library 306) that employed the Sr. Librarian. Consequently, in some embodiments, a notification may be transmitted to predefined personnel as set forth in a workflow associated with the marker, and as described hereinabove.

### EXAMPLE 2

Once an employee has left a position a question to be answered is: Should the position be locked, suppressed, blocked, or reclassified? Thus, the attributes of the position are relevant (as contrasted to the attributes of the employee). For example the condition could be ‘position=tenure position’. In this way a tenure position would be deleted while a non-tenure position would remain unaffected and consequently a new employee could be hired for this position.

### EXAMPLE 3

In some embodiments, a tree-like decision structure having at least input fields of “Monitor Condition” and “Job Position” may be used. Assume, for sake of example, that the Library's “Technical Staff Employee 2” (e.g., the Sr. Librarian) had just changed occupation state. A tree-like decision structure of this example may compare the job position (“Technical Staff Employee 2”) with one or more pre-stored Monitor Conditions. Accordingly, and for purposes of this example, if only one Monitor Condition was to be evaluated and that one Monitor Condition was “Technical Staff Employee,” then the evaluation would be favorable because the Library's Technical Staff Employee 2 position is now open. A system in accordance with an embodiment of the invention may be preprogrammed to recognize that the job position “Technical Staff Employee 2” was related to “Technical Staff Employee” and the job position “Maintenance Staff Employee 3” was related to “Maintenance Staff Employee.” In some embodiments, for example, a consultant may enter these relationships during customizing.

Tree-Like Decision Structures and User Exits

In some embodiments, the tree-like decision structure has as input parameters the attribute of Job Position and the Monitor Condition. For example, in Table 1, where the there are five entries, RLTS, TEC, MNT, ADM, and EXP, the tree-like decision structure could take as input any of the five values for the monitor condition and then check them against the attributes of “job position” of any position whose occupation state had just changed. For illustrative purposes herein, a tree-like decision structure may be represented by pseudocode that first asks, “what is the monitor condition,” if the monitor condition is “TEC,” then look at job position. If the job position is “Electrician” or “Facility Manager,” then return a YES (and, for example, execute a workflow); if the job position is different, then return a NO. Alternatively, for example, the monitor condition could be “EXP,” which is the short or technical name for “Expensive Positions.” In a tree-like decision structure examining a variable such as salary, a mathematical limit may be evaluated. For example, a tree-like structure may be represented by pseudocode that first asks, “what is the monitor condition,” if the monitor condition is “EXP,” then look at the attribute “Salary.” If the salary is higher than a predefined value, then return a YES (and, for example, execute a workflow); if lower then return a NO. The attributes of job positions may be stored, for example, in a database table 326.

A user only may be concerned with finding a correct marker type and specifying the number of positions to be changed. This is one advantage of embodiments of the method of this invention. A user need not have to consider the limits used in the evaluation. Personnel that define the business' process predefine those limits. The limits are stored in the decision structure, which is not readily accessible to an everyday user. For example, if the monitor condition is “Expensive Positions,” then a consultant, in customizing, may enter a salary limit into the decision structure; the everyday user need not be concerned with a determination of which salary level is considered “expensive.”

With tree-like decision structures there are some limits. For example, one can only use the attributes that are given to the decision structure by the original software developer. An alternative method may be to have the software developer define a “user exit.” A user exit may be described as lines of coding that a customer can fill. So again, a system administrator may generate his own unique code to handle situations that may be unique to only the particular organization of the system administrator. That is, user exits may be used where preconfigured solutions may not be available, or may be considered too difficult (due to, for example, complexity or cost restrictions) to implement. In other words, for situations that may vary widely from user to user, the software developer may provide user exits to allow each user to further address the unique situation by inserting his own code.

A user exit may include an input and an output. The input may be a job position attribute and the Monitor Condition. The system administrator may read the attributes of the job position he is interested in and create code that would evaluate whether, for a given monitor condition, the selected attributes meet a specified criteria. Providing a user exit allows a system administrator the flexibility, in effect, to generate his own tree-like decision structure, or whatever decision structure he prefers.

### EXAMPLE 4

By way of example, and in order to illustrate a use of the method of FIG. 4, assume the following, at 404, system administration may create and name a Monitor Condition “Technical Staff” (key=TEC, long name=Technical Staff, see second row in Table 1). At this point, there is only a key and a long name. At 406, system administration may associate the Monitor Condition to a required position's attribute(s). This may be accomplished with, for example, coding (using customer exits) or tree-like decision structure, both as explained above. In either instance, for this example, a system in accordance with an embodiment of the invention may first identify what the Monitor Condition is. For purposes of illustration herein, simple pseudocode IF-THEN type statements are illuminating:

IF Monitor Condition=RLTS
THEN IF Job position=Sr. Librarian OR Technical Staff Employee
   Result=YES
ELSE
   Result=NO

IF Monitor Condition=TEC
THEN IF Job position=Facility Manager OR Electrician
   Result=YES
ELSE
   Result=NO

IF Monitor Condition=ADM
THEN IF Job position=Director OR Asst. Director
   Result=YES
ELSE
   Result=NO

IF Monitor Condition=EXP
THEN IF Salary>150,000
   Result=YES
ELSE
   Result=NO

At 408, system administration may relate one or more types of markers for organizational change to a monitor condition in customizing. For example, system administration may have defined a marker type called “Technical Tasks Outsourcing” (short name “TTO”) and assigned it to the monitor condition “Technical Staff.” Table 2 illustrates a table for associating marker types with the technical names of Monitor Conditions. Here the Monitor Condition “Technical Staff” with its technical name, or key, “TEC” is associated with a marker for organizational change having a marker type of “Technical Tasks Outsourcing,” (short name=“TTO”). Additionally, the Marker Type “RIF,” which may stand for “Reduction In Force” is illustrated as being associated with the Monitor Condition “RLTS” (long name=Reduce Library Technical Staff).

TABLE 2

| Marker Type | Technical Name of Monitor Condition |
|---|---|
| TTO | TEC |
| RIF | RLTS |

At 410, a user may select a marker type (i.e., a specific marker for organizational change) and associate that marker type with an identity of an organizational unit. For example, the HR administrator responsible for the University 302 may select a marker of type “Technical Tasks Outsourcing” (short name “TTO”). Then he may associate the marker type TTO to the organizational unit LIBRARY (short name “LIB”) 306. Table 3 illustrates a table that may be used to associate an organizational unit with a marker type. Additionally, the table may include data associated with the marker type. In the example given above, the data associated with marker type TTO is nine; that is, nine positions are associated with Technical Task Outsourcing. The data represents the number of positions that are to be reduced or changed. Entry of data may be accomplished, for example, at an interactive display. Optionally, a user could also specify further data, such as a validity period over which the marker type may be validly associated with the organizational unit. For example, a fourth column in Table 3 may be used to store validity periods. In accordance with some embodiments of the invention, a validity period may be any length, for example January 2005 to December 2007. All actions taken by users may be accomplished, for example, at interactive displays using computer input and output devices.

TABLE 3

| ID of | Marker | | |
|---|---|---|---|
| Organizational Unit | Type | Number of Positions | Validity Period |
| LIB | TTO | 9 | 01/2005-12/2007 |

At 412, when a change in occupation state of a job position is detected and there is a marker on an organizational unit corresponding to the organizational unit at or above the job position, a system in accordance with an embodiment herein may evaluate whether all conditions relevant to the Monitor Conditions are satisfied by the job position attributes as predefined at 406.

Steps 410 and 412 may both be executed at runtime, but they may occur at separate times. For example, in December of 2004 a human resources manager may associate the marker TTO with the organizational unit LIB and specify that nine positions are to be outsourced. This would occur at runtime of step 410. In March of 2005, one employee may leave his position in the organizational unit. For example, one person in the technical staff of the library may retire. At 414, if all conditions are satisfied, the method may continue to 416. Otherwise the method may return to 412 and wait until the next detection of a change in occupation state of a job position occurs. At 416, a workflow associated with the marker for organizational change may be executed. Following execution, the method may return to 412 and wait until the next detection of a change in an occupation state of a job position occurs.

By way of example, at 412, a system executing code in accordance with an embodiment of a method herein may receive a signal that the occupation state of a position has changed. If being part of the library it may identify whether the position is a position assigned to technical staff. If a position for technical staff, it may identify whether that employee was employed in the Library. If employed in the Library, it may identify whether that employee was a member of the technical staff. If a member of the technical staff, it may identify if a marker had been associated with the technical staff. If a marker was associated with technical staff, it may identify whether the marker is TTO and that nine positions are slated for outsourcing. As all requirements are true, the system may execute a workflow, which may update the number of positions in Table 3 (as only one of nine available positions can be outsourced at this time). The workflow may also prevent reoccupation of the position that fulfilled the criteria defined by the monitor condition. The workflow may also transmit notification to one or more persons, as described previously.

While there has been described what are believed to be the preferred embodiment of the present invention, those skilled in the art will recognize that other and further changes and modifications may be made thereto without departing from the spirit of the invention, and it is intended to claim all such changes and modifications as falling within the true scope of the invention.

What is claimed is:

1. A method of causing the execution of a predefined set of instructions upon an occurrence of an organizational change in an organizational unit, comprising:
detecting a change in an occupation state of at least one position in a plurality of positions;
determining if a marker for organizational change is associated with an organizational unit at or above the organizational unit associated with the position; and
executing the predefined set of instructions if a marker for organizational change is associated with the organizational unit at or above the organizational unit associated with the position.

2. The method of claim 1, wherein the predefined set of instructions causes a transmission of a notification to one or more users.

3. The method of claim 1, wherein the predefined set of instructions locks, suppresses, blocks, or reclassifies the position.

4. A method of causing the execution of a predefined set of instructions upon occurrence of an organizational change in an organizational unit, comprising:
detecting a marker for organizational change, wherein:
the marker is of a first type in a plurality of types,
the marker is set to a state having a value indicative of an organizational change within an organizational unit associated with the marker, and
the organizational change is associated with a first position in a plurality of positions;
determining a monitor condition associated with the first type of marker for organizational change;
determining as a function of the monitor condition and one or more attributes associated with the first position whether all conditions relevant to the monitor condition and set forth in a predefined decision structure are satisfied; and
executing a predefined set of instructions if all conditions are satisfied.

5. The method of claim 4, wherein the conditions relevant to the monitor condition comprise associations between a position's attribute and the monitor condition.

6. The method of claim 5, wherein the attribute comprises a location, a payscale, or a qualification profile.

7. The method of claim 4, wherein the decision structure is one of a tree-like decision structure and a user defined decision structure

8. The method of claim 7, wherein the user defined decision structure is accessed via a user exit.

9. The method of claim 4, wherein the executed set of predefined instructions causes a transmission of a notification to one or more users.

10. The method of claim 4, wherein the executed set of predefined instructions locks, suppresses, blocks, or reclassifies the position.

11. The method of claim 4, wherein the executed set of predefined instructions is an automated process that passes information from one resource to another according to a set of procedural rules.

12. The method of claim 4, wherein the executed set of predefined instructions is an automated process that executes a task according to a set of procedural rules.

13. A system to execute a predefined set of instructions, comprising:
a processor; and
a memory, the memory storing executable code comprising instructions to:
detect a marker for organizational change, wherein:
the marker is of a first type in a plurality of types, the marker is set to a state having a value indicative of an organizational change within an organizational unit associated with the marker, and
the organizational change is associated with a first position in a plurality of positions;
determine a monitor condition associated with the first type of marker for organizational change;
determine as a function of the monitor condition and one or more attributes associated with the first position whether all conditions relevant to the monitor condition and set forth in a predefined decision structure are satisfied; and
execute a predefined set of instructions if all conditions are satisfied.

14. The system of claim 13, further comprising an output device, wherein the execution of the predefined set of instructions causes a transmission of a notification to the output device.
